(19) United States
(12) Patent Application Publication
(10) Pub. No.: US 2009/0096380 A1
(43) Pub. Date: Apr. 16, 2009

(54) System and method for producing energetic particles by gas discharge in deuterium containing gas

(76) Inventors: Brian Scanlan, Greenwich, CT (US); Edmund Storms, Santa Fe, NM (US)

Correspondence Address: PATTON BOGGS LLP, 2550 M STREET NW, WASHINGTON, DC, 20037-1350, US

(21) Appl. No.: 11/907,433

(22) Filed: Oct. 12, 2007

(51) Int. Cl. H01J 7/24

(52) U.S. Cl. 315/85; 315/111.01

(57) ABSTRACT

A system for producing energetic particles including a housing containing an anode and a cathode, wherein the anode is connected to a voltage supply and the cathode is one of a cathode containing an oxide layer and a cathode in the presence of oxygen, said cathode is grounded; a vacuum source connected to the housing for providing a reduced pressure in the housing; and a supply of at least one gas connected to the housing for introducing the at least one gas into the housing containing deuterium and oxygen.

### FIELD OF THE INVENTION

The field of the invention relates to methods and apparatus for generating energetic emissions, and more specifically generating energetic cathode emissions during low-voltage discharge of a gas containing deuterium.

### BACKGROUND OF THE INVENTION

Nuclear reactions have been observed to occur at low energy under conditions normally thought not to allow such reactions. This new field of study, called Low Energy Nuclear Reactions (“LENR”), is described most recently by Storms (The Science of low energy nuclear reaction, World Scientific, Singapore, 2007). A growing number of studies have claimed to produce detectable heat, radiation of various types, and nuclear products from reactions similar to fusion, fission and transmutation. The challenge has been to produce these reactions at high levels with easy and consistent replication.

The first evidence for such reactions was provided by Fleischmann and Pons (. Electroanal. Chem. 261, 301 and errata in Vol. 263 (1989); J. Electroanal. Chem. 287, 293 (1990)) using the electrolysis of D₂O+LiOD. Because of the difficulty in causing LENR using this method, researchers have successfully applied a variety of other methods, including gas discharge. Even though many successful replications have been published using several different methods, much skepticism still remains about the reality of such nuclear processes.

One problem with prior art reactions is that they are not capable of producing repeatable, detectable, and measurable energetic particles. The results produced by prior art reactions are intermittent, difficult, and/or impossible to measure. Such intermittent results lead some to question whether such LENR reactions actually take place.

Further, prior art reactions require significant amounts of time to set up and run. For example, some prior art reactions require weeks or months for results to appear and positive results are rare.

In addition, many prior art reactions utilize an anode made from tungsten, which in the presence of oxygen and high voltage causes the tungsten to oxide. In such reactions, an oxidized anode will either partially reduce or eliminate the ability to cause a discharge. Thus, these prior art reactions that use tungsten anodes and high voltage—will be less successful because the required oxygen will be removed from the gas.

### SUMMARY

The above described problems are solved and a technical advance achieved by the present System and Method for Producing Energetic Particles (“Energetic Particles System”).

In one embodiment, an electric discharge is created at less than 1000 V in low-pressure gas containing deuterium. As a result, energetic particle emission is easy to produce at high levels when certain critical conditions exist. In addition to deuterium, a preferred embodiment of the present Energetic Particles System uses monoatomic oxygen, diatomic oxygen, or both as the initial form of oxygen.

In the present invention, an electric discharge may be created at less than 1000 V in low-pressure gas containing deuterium. However, this invention does not limit the voltage to 1000V. As a result, energetic particle emission is easy to produce at high levels when certain critical conditions exist. A thin-window Geiger-Müller (GM) detector, located within the cell, is used to measure the radiation.

The claims for measurable heat production have been rejected, to a large extent, because the radiation expected to be produced by conventional nuclear reactions was not detected on many occasions. Several theories have been proposed to account for this absence. In view of this work as well as other observations listed in Table 1, the absence of radiation no longer needs to be explained because it is clearly present and can be measured if suitable detectors are used. A thin-window GM detector, located within the cell, is used to measure the radiation. This radiation results in heat energy being deposited in the apparatus, which if sufficiently intense, can result in a practical source of heat energy.

The present Energetic Particles System produces repeatable, detectable, and measurable energetic particles in a substantially shorter period of time relative to prior art LENR reactions. The Energetic Particles System is capable of producing energetic particles in a relatively short period of time, such as within minutes for each operation. In one embodiment, monoatomic oxygen, diatomic oxygen, or both is a part of the initial mixture of gases used during the operation of the Energetic Particles System.

In one embodiment, the present Energetic Particles System includes a housing containing an anode and a cathode, wherein the anode is connected to a voltage supply and the cathode acquires an oxide surface layer and is grounded; a vacuum source connected to the housing for providing a reduced pressure in the housing; and a supply of at least one gas connected to the housing for introducing the at least one gas into the housing.

### BRIEF DESCRIPTION OF THE DRAWINGS

FIG. 1 illustrates a schematic diagram of the Energetic Particles System according to an embodiment of the present invention;

FIG. 2 illustrates a schematic diagram of the Energetic Particles System according to another embodiment of the present invention;

FIG. 3 illustrates a top view of the Energetic Particles System according to another embodiment of the present invention;

FIG. 4 illustrates a side view of the Energetic Particles System of the embodiment shown in FIG. 3 of the present invention;

FIG. 5 illustrates a schematic diagram of a vacuum apparatus of the Energetic Particles System according to an embodiment of the present invention;

FIG. 6 illustrates a cross-section view of a cathode assembly of the Energetic Particles System according to an embodiment of the present invention;

FIG. 7 illustrates a side view of the an absorber assembly of the Energetic Particles System according to an embodiment of the present invention;

FIG. 8 illustrates an axial view of an absorber of the Energetic Particles System according to an embodiment of the present invention;

FIG. 9 is a plot of analog voltage from a GM tube on scale 1 as a function of time after current was applied;

FIG. 10 is a plot of the log activity vs time after current turned off;

FIG. 11 is a plot of the activity as a function of time for a platinum cathode;

FIG. 12 is a plot of the activity vs time after current had been stopped for various times;

FIG. 13 is a plot of log fraction reduction in activity after current is stopped and restarted after indicated delay;

FIG. 14 is a plot of the effect of D₂ pressure on the activity;

FIG. 15 is a plot of the activity as a function of time at different applied current;

FIG. 16 is a plot of the change in anode voltage with time at various currents;

FIG. 17 is a plot of the effect of current on the activity;

FIG. 18 is a plot of the effect on activity of changing the D2 gas in the cell;

FIG. 19 is a plot of the effect of absorber thickness on the relative activity;

FIG. 20 is a plot of the effect of using a Teflon shroud;

FIG. 21 is a depiction of a surface of a Pd+Pt alloy after being subjected to gas discharge in D₂using a ceramic shroud;

FIG. 22 is a plot of the effect of voltage on the activity at two different total pressures;

FIG. 23 is a plot of the effect of current on the activity at two different total pressures;

FIG. 24 is a plot of the relationship between anode voltage and total pressure;

FIG. 25 is a plot of the effect of H₂O, H₂ and D₂O on the relationship between anode voltage and activity;

FIG. 26 is a plot of the effect of various amounts of D₂ mixed with O₂;

FIG. 27 is a plot of the effect of addition of He to a mixture of D₂O and O₂;

FIG. 28 is a plot of the effect of the exposed area of the cathode;

FIG. 29 is a plot of the effect of anode-cathode distance;

FIG. 30 is a plot of the slope vs distance;

FIG. 31 is a plot of the critical voltage vs distance;

FIG. 32 is a plot of the discharge resistance vs distance;

FIG. 33 is a plot of the effect of O17 (70%) oxygen enrichment on the behavior;

FIG. 34 is a plot of the examples of the effect of various D/O ratios on the behavior of activity;

FIG. 35 is a plot of the relationship between slope of volt vs activity and the D/O atom ratio;

FIG. 36 is a plot of the relationship between log slope and log D/O ratio;

FIG. 37 is a plot of the relationship between log critical voltage and log D/O ratio;

FIG. 38 is a plot of the relationship between reaction events at the cathode vs anode voltage; and

FIG. 39 is a process flow diagram for producing energetic particles according to an embodiment of the present invention.

### DETAILED DESCRIPTION OF THE DRAWINGS

In the drawings, like or similar elements are designated with identical reference numerals throughout the several views and figures thereof, and various depicted elements may not be drawn necessarily to scale.

The term “energetic particles” includes radiation consisting of helium, proton, deuteron, triton, or electrons. Further, the term “energetic particles” means high energy particles, which include electrons, protons, deuterons, tritons, and alphas.

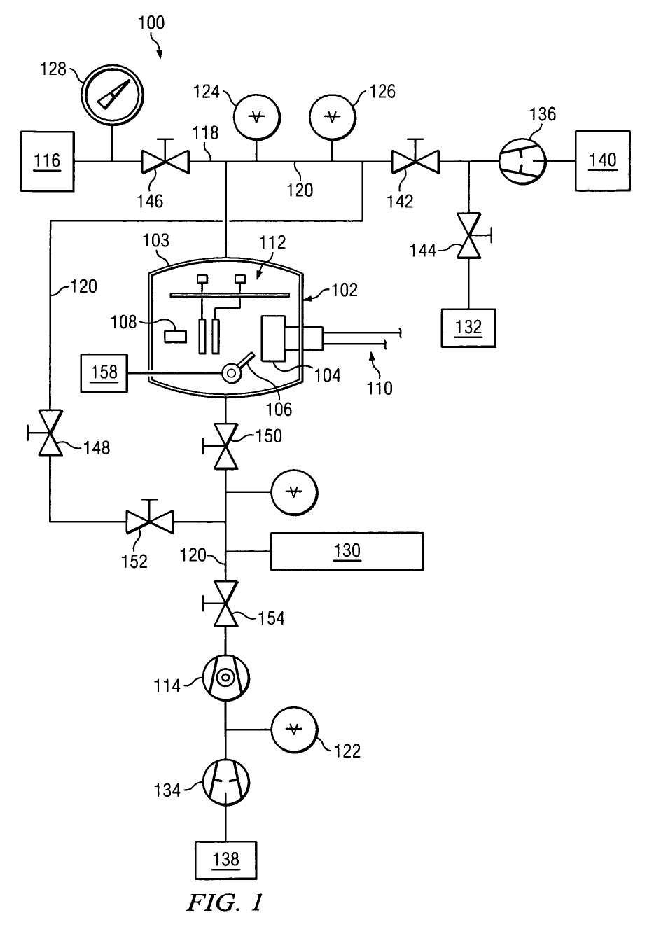

FIG. 1 illustrates an embodiment 100 of an Energetic Particles System that includes a gas discharge cell 102 including a housing 103 that contains a cathode 104 and an anode 106 for producing a discharge in the gas discharge cell 102. In this embodiment, the gas discharge cell 102 further contains a gaseous ionization detector, such as a Geiger-Mueller tube (“GM tube”) 108, that detects particles of ionizing radiation within the gas discharge cell 102. A coolant, such as water, is supplied to the cathode 104 via coolant lines 110. The gas discharge cell 102 further may include an absorber 112.

A vacuum source 114, such as a turbomolecular pump, provides a source of vacuum or negative pressure via vacuum supply lines 120 to the gas discharge cell 102. Preferably, the vacuum source 114 produces a vacuum of less than 10⁻⁶ Torr in the gas discharge cell 102 during operation. A single gas or mixture of gases, gas supply 116, is supplied to the gas discharge cell 102 via gas supply lines 118. Vacuum gauges 122, 124 and 126 measure the magnitude or amount of vacuum applied to the vacuum supply lines 120 and gas discharge cell 102. A pressure gauge 128 measures the magnitude or amount of gas supplied from the gas supply 116 to the gas supply lines 118 and gas discharge cell 102. Preferably, a residual gas analyzer (“RGA”) 130 is provided to allow gas in the gas discharge cell 102 to be analyzed up to mass/charge=50. In addition, pumps 134 and 136, such as rotary vane pumps, may be connected to air supplies 138 and 140. Valves 142, 144, 146, 148, 150, 152, and 154 control the flow of gases as described herein. In addition, anode 106 is connected to an adjustable voltage supply 158 for supplying a desired positive potential to the anode 106. The voltage supply is required to supply sufficient voltage to cause particle emission and to supply the required current at that voltage. In one embodiment, the voltage supply provides a constant voltage in the range of from about 0 V to about 1000 V. In another embodiment, the voltage supply provide a pulsing voltage in the range of from about 0 V to about 1000 V. Generally, a pulsed voltage supply may be use to provide higher voltages for long periods of time.

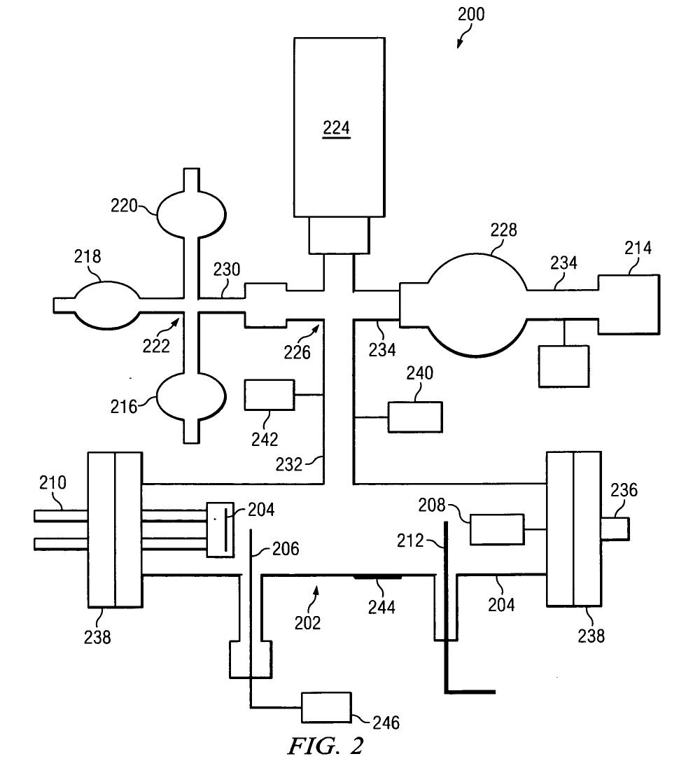

FIG. 2 illustrates another embodiment 200 of an Energetic Particles System that includes a gas discharge cell 202 including a housing 204 that contains a cathode 204 and an anode 206 for producing a discharge in the gas discharge cell 202. In this embodiment, the gas discharge cell 202 further contains a GM tube 208 that detects particles of ionizing radiation within the gas discharge cell 202. A coolant, such as water, is supplied to the cathode 204 via coolant lines 210. The gas discharge cell 202 further may include an absorber 212.

A vacuum source 214, such as a turbomolecular pump, provides a source of vacuum or negative pressure via vacuum supply lines 234 to the gas discharge cell 202. Preferably, the vacuum source 214 produces a vacuum of less than 10⁻⁶ Torr in the gas discharge cell 202 during operation. The amount of vacuum may be controlled by valve 228. A single gas or mixture of gases may be supplied to the gas discharge cell 202 via gas supply line 230. In this embodiment, three gas supplies 216, 218, and 220 are shown. Gas supply 216 may contain gaseous deuterated water, D₂O; gas supply 218 may contain gaseous deuterium; and gas supply 220 may initially contain monoatomic oxygen, diatomic oxygen, or both. Valve 222 controls the types and amounts of the gas supplied to the gas discharge cell 202. The gas supplied to the gas discharge cell 202 through gas supply line 230 may be further under control of valve 226. Valve 226 may further control the amount of vacuum supplied to the gas discharge cell 202. A pressure gauge 224 may be used to measure the positive or negative pressure of either the gas or vacuum supplied to the gas discharge cell 202 during its operation. Additional gauges, such as vacuum gauges and pressure gauges may be used in addition to the pressure gauge 224.

Additionally, a RGA 240 may be used to analyze the mass/charge ratio gas entering or exiting the gas discharge cell 202 through the supply line 232. An ion analyzer 242 may be connected to the supply line 232 for analyzing the ions in either the vacuum supply lines 234 or the gas supply line 230 when it contains the residual or exit gas that is transported from the gas discharge cell 202. In addition, pumps (not shown), such as rotary vane pumps, may be connected to air supplies for supplying air to the gas discharge cell 202. Additional valves (not shown) may be used to further control the flow and amounts of gases and vacuum or negative pressure to the gas discharge cell 202. A glass window 244 is shown along one side of the gas discharge cell for viewing purposes. The gas discharge cell 202 may further include end flanges 238 that seal the gas discharge cell 202 and provide through ports or passageways for the cooling lines 210 and electrical connectors 236 that supply electricity to the GM tube 208. In addition, anode 206 is connected to an adjustable voltage supply 246 for supplying a desired positive potential to the anode 106.

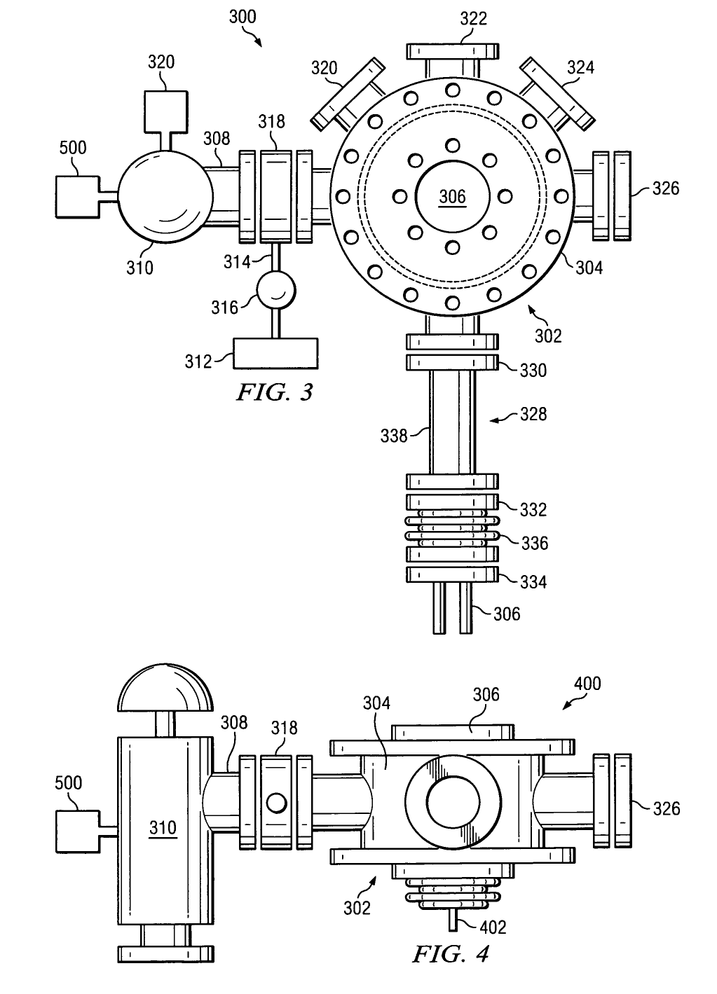

FIG. 3 illustrates yet another embodiment 300 of an Energetic Particles System that includes a gas discharge cell 302 including a housing 304 that contains a cathode (not shown) and an anode 402 (FIG. 4) for producing a discharge in the gas discharge cell 302. In this embodiment, the gas discharge cell 302 further contains a GM tube (not shown), that detects particles of ionizing radiation within the gas discharge cell 302. A coolant, such as water, is supplied to the cathode via coolant lines 306. The gas discharge cell 302 further may include an absorber (not shown) that may be operated from outside the gas discharge cell 302 by external controls, such as magnets, at the window 306 as further described below. Detectors 320, 322, and 324 may be used to detect or analyze the mass/charge ratio or ions contained in the gas entering or exiting the gas discharge cell 302. The gas discharge cell 302 may further contain a viewing window 326.

The gas discharge cell 302 may further include a nipple 328 that comprises a pipe 338 and several flanges 330, 332, and 334 that provide additional flexibility between the coolant lines 306 and the housing 304. In one aspect, a bellows 336 is located between a set of flanges 332 and 334 to enable the distances between the anode and cathode to be adjustable. FIG. 4 illustrates a side view of an embodiment 400 of the gas discharge cell 302 as shown in FIG. 3. FIG. 4 depicts a preferred location of the anode 402 entering the housing 304 of the gas discharge cell 302.

A single gas or mixture of gas supplies 312 maybe supplied to the gas discharge cell 302 via gas supply line 314. Gas supply 312 may contain gaseous deuterated water, (D₂O), gaseous deuterium (D₂); oxygen (O); and/or oxygen (O₂). Valve 316 controls the types and amounts of the gas supplied to the gas discharge cell 302. The gas supplied to the gas discharge cell 302 through gas supply line 314 may be transported through a flange 318 that may also connect the vacuum source 500 to the gas discharge cell 302. Valve 310 may further control the amount of vacuum supplied to the gas discharge cell 302. A pressure gauge 320 may be used to measure the positive or negative pressure of either the gas or vacuum supplied to the gas discharge cell 302 during its operation. Additional gauges, such as vacuum gauges and pressure gauges may be used in addition to the pressure gauge 320.

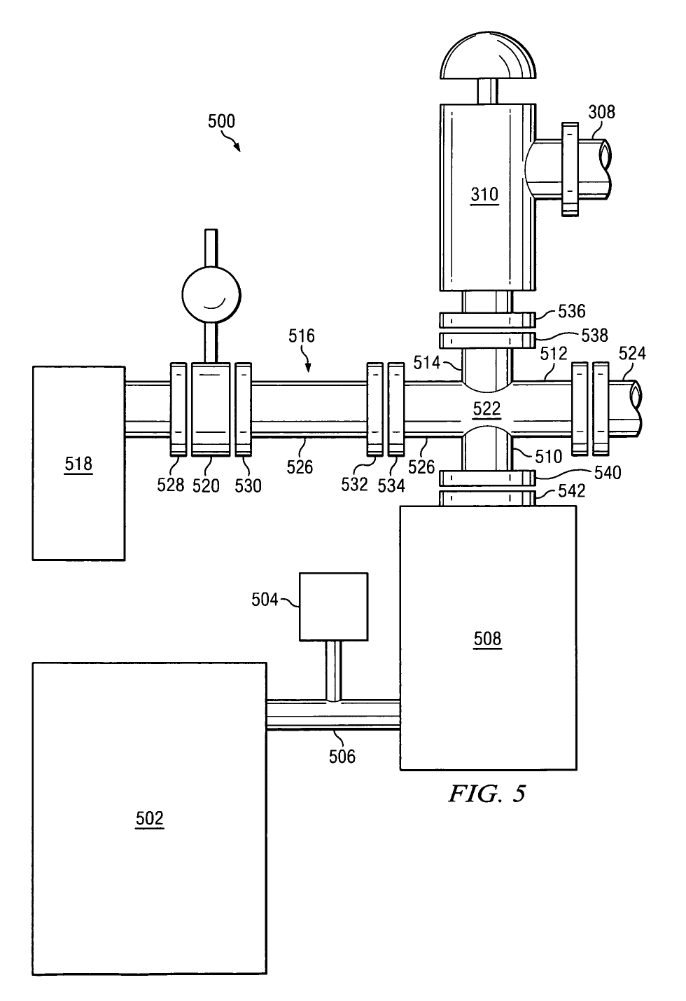

FIG. 5 illustrates an embodiment 500 of a vacuum source that is connected to valve 310. A mechanical pump 502 is connected to a vacuum apparatus 508 via connection line 506 that may further include a gauge 504, such as a thermocouple gauge. The vacuum apparatus 508 is connected to valve 522 via vacuum supply line 510 for supplying the vacuum or negative pressure to the gas discharge cell 302 via vacuum supply line 514. An ion analyzer 524 may be connected to the valve 522 via analyzer line 512 for analyzing the ion content of either the gas entering and/or exiting the gas discharge cell 302. Additionally, a valve 520 is located between a RGA 518 and a nipple 516. The nipple 516 may include one or more pieces of line or pipe connected together by flanges 528, 530, 532, and 534. Additional flanges 536, 538, 540, and 542 maybe also used to connect the valve 522 with the vacuum apparatus 508 and the valve 310. The vacuum source 500 provides a source of vacuum or negative pressure via vacuum supply line 308 to the gas discharge cell 302. Preferably, the vacuum source 500 produces a vacuum of less than 10⁻⁶ Torr in the gas discharge cell 302 during operation. The amount of vacuum may be controlled by valve 310. Preferably, the vacuum source 500 is used to remove contaminants from the gas discharge cells. In another embodiment, a vacuum source 500 may not be needed for the operation of the gas discharge cell.

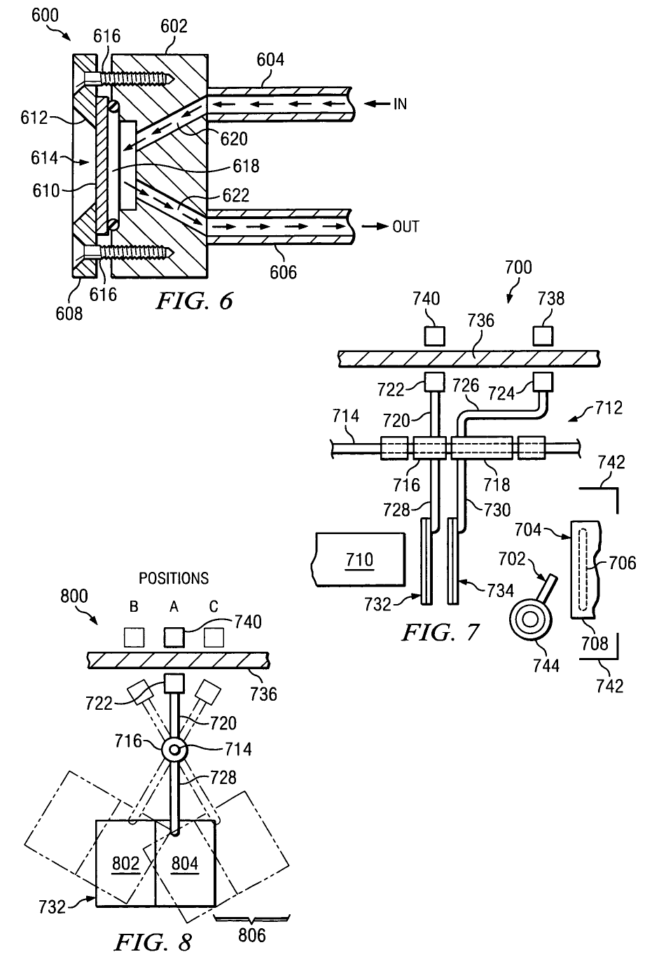

FIG. 6 illustrates an embodiment 600 of a cathode assembly of the present Energetic Particles System. The cathode assembly 600 may be used with any of the above-described embodiments of the Energetic Particles System. The cathode assembly 600 includes a manifold block 602 that has an inlet channel 620 and an outlet channel 622 formed within the manifold block 602 to facilitate the flow of coolant from the coolant lines described previously. The inlet channel 620 is in communication with an inlet line 604 and the outlet channel 622 is in communication with an outlet line 606. In one aspect, coolant flows through the manifold block 602 in the direction of the arrows. In one embodiment, space 618 is formed by a notch in the manifold block 602 and a cathode disc 610, which are sealed together by an o-ring 612. The space 618 provides a small dynamic reservoir for the coolant to contact the backside of the cathode disc 610 to remove heat from the cathode disc 610 during operation. In one embodiment, the cathode disc 610 is held in place by a retainer plate 608 that is secured to the manifold block 602 by one or more fasteners 616, such as screws, pins, and the like. The front side of the cathode disc 610 faces outward through an opening 614 in the retainer plate 608.

In addition, the gas discharge cells described above may further include shroud component 742, which surround the non-cathode portions, as shown in FIG. 7. The shroud 742 insulates every part of the cathode assembly from the glow discharge effect of the gas discharge cells with the exception of the cathode disc. The shroud preferably must cover the cathode to the extent that the discharge is forced to occur in a localized region on the face of the cathode. The shroud 742 forces the glow discharge to a concentrated region within the gas discharge cells.

FIG. 7 illustrates an embodiment 700 of the inside of the housing of a gas discharge cell of any embodiment previously described showing an absorber assembly 712. As described above, the housing includes an anode 702 and a cathode assembly 704 that includes a cathode disc 706 and a retainer plate 708. In one embodiment, the tube 744 from which the anode emerges is a glass-filled insulator. The GM tube 710 is located on the other side of the absorber assembly 712 from anode/cathode combination. The absorber assembly 712 includes a fulcrum pin 714 on which hubs 716 and 718 may freely pivot. In one embodiment, hub 718 is connected to a first arm 726 that is connected distally to a magnet 724, and hub 718 is connected to a second arm 730 that is connected distally to a first absorber plate 734. Likewise, hub 716 is connected to a first arm 720 that is connected distally to a magnet 722, and hub 716 is connected to a second arm 728 that is connected distally to a second absorber plate 732. As first arms 726 and 720 rotate in a direction, the second arms 730 and 728 rotate in the same direction, thus when the first arms 726 and 720 are moved in a downward direction the second arms 730 and 728 are caused to move in the upward direction, because the hubs 716 and 718 pivot about fulcrum pin 714. Conversely, when the first arms 726 and 720 are moved in an upward direction, the second arms 730 and 728 are caused to move in the downward direction.

As described above, a window 736 is formed into the housing of a gas discharge cell and allows for magnets 738 and 740 on the external side of the housing to influence magnets 722 and 724 on the internal side of the housing. Thus, when the magnets 738 and 740 are moved in a downward or upward direction, the magnets 722 and 724 are moved in a corresponding direction. This enables an operator to control the movement or position of the absorber plates 732 and 734 by moving magnets 740 and 738 outside of the housing of a gas discharge cell.

FIG. 8 illustrates an axial view of an embodiment 800 of the absorber plate 732 that includes a first absorber 802 and a second absorber 804. In one embodiment, the first absorber 802 and second absorber 804 are sheet type materials having a thickness necessary to provide absorbing properties to the energetic particles that are directed to it from the anode/cathode combination. In one embodiment, the first absorber 802 and second absorber 804 are joined along one side to produce a single sheet that is connected to the second arm 728. The second arm 732 is connected to the hub 716 that pivots about fulcrum pin 714. In another embodiment, the hubs maybe fixed in part to the fulcrum pin, which may be rotated by a motor.

As discussed above, the absorber plate 732 may be moved to various positions, such as shown as Positions: “A,” “B,” and “C” When the magnet 740 is placed in Position A the first absorber 802 is substantially located directly between the GM tube and the anode/cathode combination. When the magnet 740 is placed in Position C the second absorber 804 is substantially located directly between the GM tube and the anode/cathode combination. When the magnet 740 is placed in Position B neither the first absorber 802 nor the second absorber 804 are substantially located directly between the GM tube and the anode/cathode combination, thus this position may be considered an open position.

The above description regarding the absorber plate 732 further applies to absorber plate 734. Preferably, it includes two different types of material and forms a sheet type absorber plate for use with the absorber plate 732. Thus, when the absorber plate 732 and absorber plate 734 are used together, many different combinations of absorbent material may be located substantially between the GM tube and the anode/cathode combination. Additionally, the absorber plates may have different thicknesses to allow the energy and type of the radiation to be determined by an energetic particles detector, such as a GM tube as described herein. The absorber materials and thicknesses are chosen in order to stop the energetic particles from reaching the GM tube. In addition, by making the proper choice, the energy of the radiation can be estimated.

The gas discharge cells 102, 202, and 302 may be made of a material that is gas tight and non-reactive with the gases contained within it. In one example, the gas discharge cells are made from borosilicate glass (Pyrex®) material. Glass to metal adaptors may be used to join portions of the gas discharge cells that are metal to those that are glass. Further, the gas discharge cells should be capable of withstanding the vacuum that is supplied to the cells during operation. In one embodiment, the housings of the gas discharge cells may be made from tube-shaped materials, such as borosilicate glass. The housing may further include end plates, such as shown as flanges 238. Preferably, the discharge cells can be made of any material that is able to withstand the low pressure without rupture or excessive release of gas.

In one aspect, the cathode is grounded to the gas discharge cell. An electrical discharge is produced by using a power supply rated at preferably 1.5 A and 2000 V running under current control. In one embodiment, voltage is supplied to the anode through a forced-air cooled resistor of 300 ohm. In one aspect, the supplied current and the voltage at the anode are measured approximately every 6 to 60 seconds and the values are made a permanent record and stored along with the voltage produced by the count rate. Preferably, computers and computing systems are utilized to collect and store the data. In one aspect, the anode is supplying the positive full potential and the cathode itself is grounded as described herein. In one embodiment, the cathode is grounded to one of the flanges or housing.

As discussed below, the amount of radiation was proportional to a voltage that averaged the count rate with a maximum value of 0.6 V before the circuit became saturated. This maximum was produced by approximately 5000 counts/sec on scale 10. Later, the count rate was measured directly, which allowed much greater values to be determined. This final design allowed reaction rates in excess of 10⁹/sec to be measured, a limit that was imposed only by unwanted electrical discharge to the body of the cell.

The vacuum source 114, 214, and 314 for any of the gas discharge cells 102, 202, and 302 may be any type of device or apparatus that provides a sufficient amount of vacuum to the gas discharge cell. In one embodiment, the pressure within the gas discharge cell is decreased by the vacuum source prior to adding the deuterium containing gas into the housing of the gas discharge cell. Vacuum sources may include turbomolecular pumps and mechanical pumps, such as rotary vane pumps.

The gas supplied to the gas discharge cells gas discharge cell 102, 202, and 302 may be any one or a mixture of deuterated water (D₂O), deuterium (D₂), monoatomic oxygen (O), and diatomic oxygen (O₂) hydrogen (H2) or normal water (H2O) gases. These gases may be stored in conventional compressed gas bottles or produced directly by such type of gas generators. In addition to that described herein, regulators, valves, piping, and the like, may be used to supply a gas or mixture of gases to the gas discharge cell.

The GM tube 108, 208, and 710 preferably have electrical connections that extend through the flanges, through ports, feed through, or passageways of the gas discharge cell and are connected to an electrical supply. In addition, the GM tube may include an end-window of mica preferably with 1.5-2.0 mg/cm² (LND 712).

The coolant lines 110, 210, and 310 provide a coolant to the cathode as discussed above. The coolant may be water that is circulated to a cooling apparatus the reduces the temperature of the water before it is transported back to the cathode for providing cooling effects. A refrigerated reservoir may also included in a continuous loop containing the coolant lines for reducing the temperature of the coolant contained in the coolant lines.

In one embodiment, the anode 106, 206, and 702 is a 2 mm diameter wire covered by a glass insulator. The anode material is preferably a metal that does not easily oxidize such as a noble metal. In one aspect, the wire is palladium. A variety of cathode and anode materials have been explored. The cathode materials include, but are not limited to Cu, Pd, Mn, Mg, Al, Na, Si, Cr, Ca, Fe, K, Pt, Re, Mo, Ti Ag, Ni and stainless steel or alloys thereof. These materials are preferred to have certain properties. For example, Cu and Ag generally sputter too rapidly to provide energetic particles for extended periods of time and Ti and other easily oxidized metals form an insulating layer that interferes with the discharge. Plated cathodes are generally not practical because the coating quickly sputters away. A preferable cathode material is stainless steel. The anode preferably needs to be made of a metal, such as Pd or Pt that does not oxidize in an oxygen containing atmosphere when it gets hot. For this reason, the commonly used tungsten anode is generally not suitable using the gas composition.

In one embodiment, the cathode 104, 204, and 706 is generally surrounded by the insulating shroud. The cathode surface experiencing the discharge is a thin metal disc; the cathode is directly cooled by a coolant as discussed above. This design can dissipate power in excess of 300 watts, permitting a wide range of current and voltage to be used.

The vacuum gauges described above measure the gas pressure within the cell during discharge. In one aspect, the gauges are Baratron gauges capable of measuring 0-10 and 0-100 Torr.

At least two different kinds of energetic particle radiation, Energetic Electron (“EE”) and Charged Particle (“CP”), are emitted from a cathode while exposed to low-voltage gas discharge in deuterium. This radiation is detected using a thin-window GM tube located within the apparatus close to the source of radiation as described herein. Generally, no radiation was detected outside of the gas discharge cell using a similar GM tube or detector as found inside the gas discharge cell.

The EE is produced at a low rate under conditions. Consequently, its appearance is less reproducible that CP. On the other hand, the CP can be produced at high rates and, because the conditions are well understood, its production is completely reproducible within the gas discharge cell.

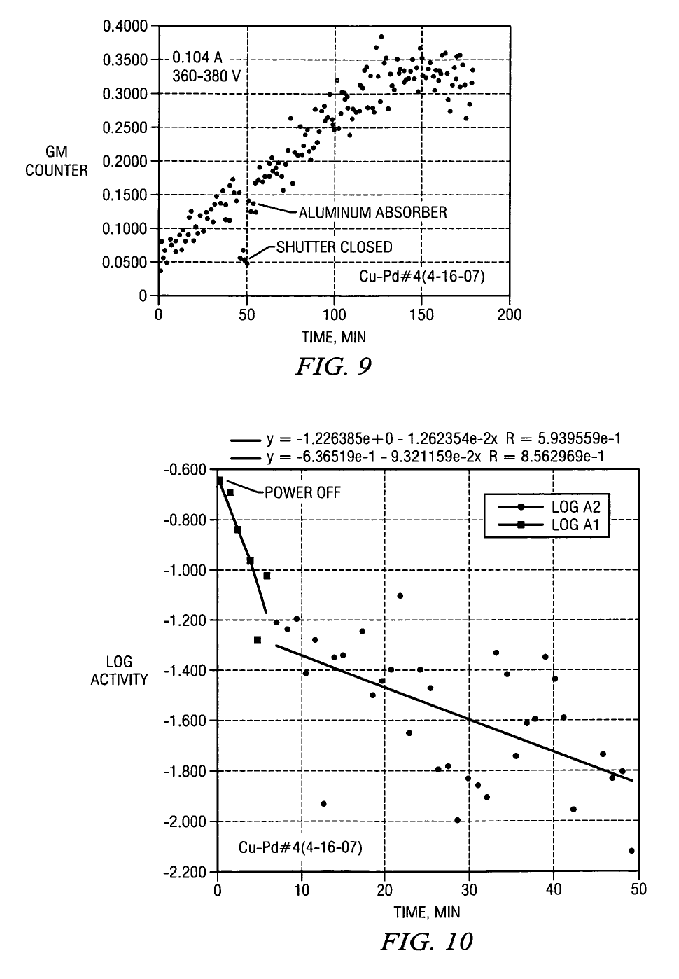

FIG. 9 is a plot of analog voltage from a GM tube on scale 1 as a function of time after current was applied. A gas discharge cell containing a shroud machined from boron nitride (“BN”) and a cathode disc made by electroplating copper with palladium to a thickness of 7.5 μm that was loaded with about 35 Torr of D₂ gas. When a current of 0.107 A (360 V) was applied, a uniform blue-colored discharge was produced over the cathode surface and the activity increased over a period of 150 min, as plotted in FIG. 9. Insertion of a copper absorber (521 mg/cm²) reduces activity nearly to zero while aluminum foil (4.6 mg/cm²) had very little effect. This thickness of aluminum combined with the thickness of the GM tube window will stop electrons having an energy less then 70 keV and alpha particles having energy less than 7.6 MeV. The absorbers also blocked light from the discharge that might be proposed as the source of the apparent emission.

When the current was turned off at 175 min, a reduction in activity was observed. Activity after current interruption is plotted as log activity vs time in FIG. 10. Two decay rates are revealed with half-lives of 24 min and a much less certain decay of 182 min. A decay after the current is stopped was never seen again for any sample. In all other cases, the activity dropped to zero within the time constant of the detector, which is a few seconds. FIG. 10 is a plot of the log activity vs time after current turned off.

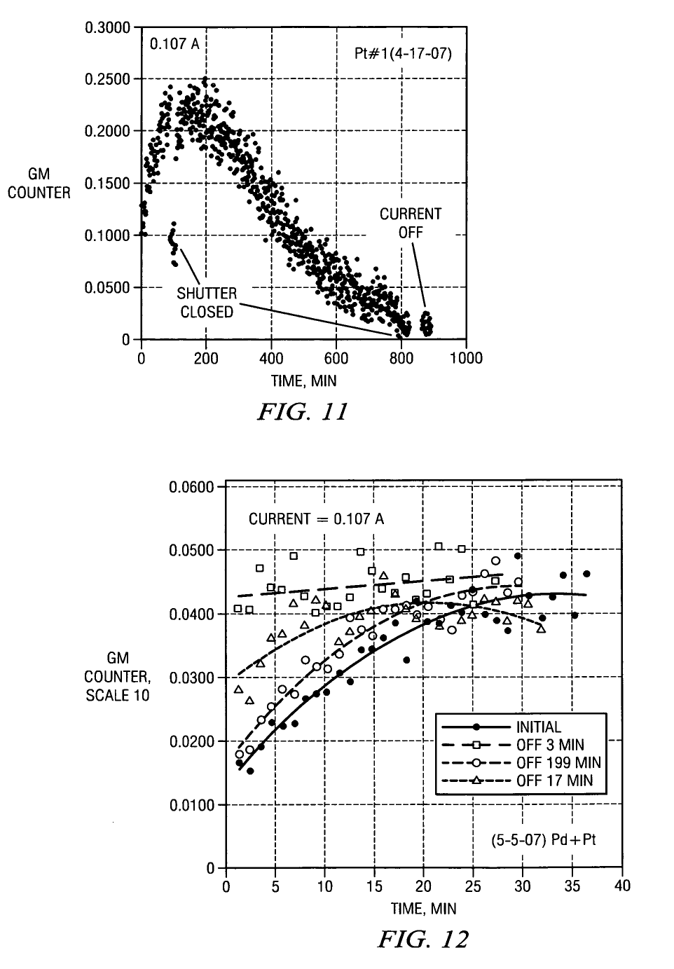

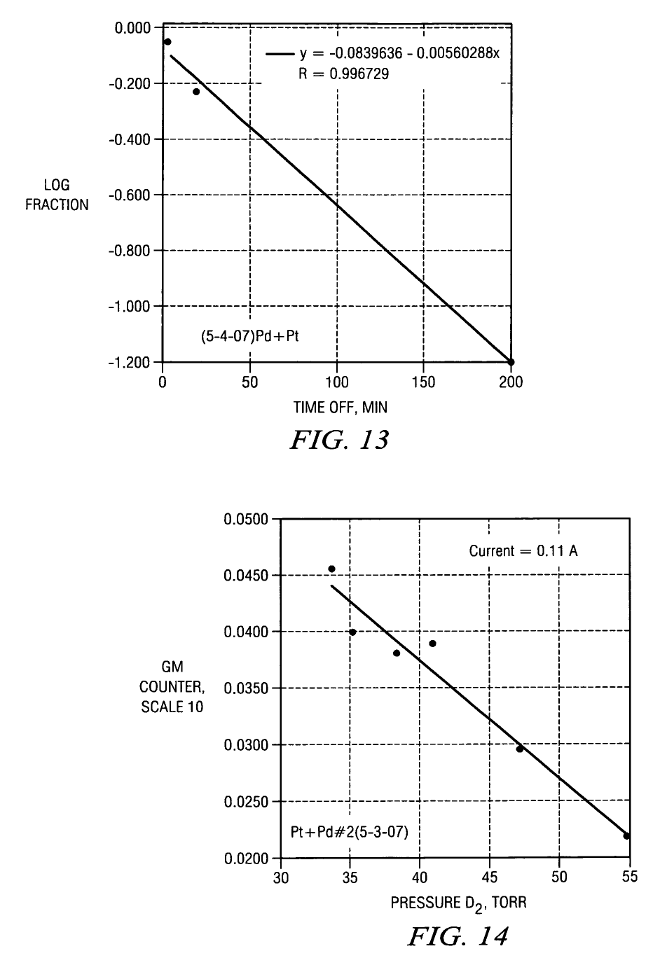

Activity was typically found to slowly increases and then decay away as current application continued, as shown in FIG. 11, which is a plot of the activity as a function of time for a platinum cathode. Some samples achieved a constant activity long enough to make additional measurements. If current was stopped after the maximum activity had been reached and was reapplied after a variable delay, the behavior shown in FIG. 12 was produced. FIG. 12 is a plot of the activity vs time after current had been stopped for various times. When current is stopped for a brief time, activity starts near to the value it had before current was stopped. On the other hand, if delay is too long, activity starts near zero. This behavior is shown in FIG. 13, where the log fraction of maximum activity is plotted as a function of the delay before the current was reapplied. FIG. 13 is a plot of log fraction reduction in activity after current is stopped and restarted after indicated delay. Although the data are limited, this behavior is expected to be produced by a first order reaction having a half-life of 24-54 min, with the first value being the most likely.

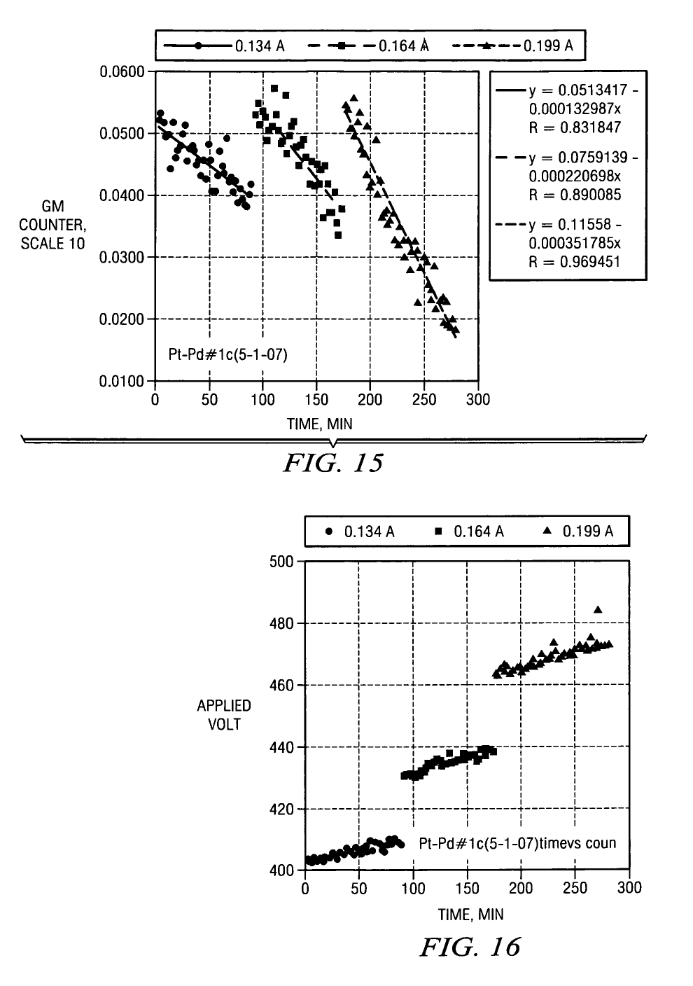

Activity is a function of D₂ gas pressure, as plotted in FIG. 14. FIG. 14 is a plot of the effect of D₂ pressure on the activity. When current is changed, which also changes the anode voltage, behavior plotted in FIG. 15 is produced. FIG. 15 is a plot of the activity as a function of time at different applied current. Activity increases when current is increased, but then drops more rapidly over time. This reduction in activity is associated with a corresponding increase in anode voltage, as shown in FIG. 16. FIG. 16 is a plot of the change in anode voltage with time at various currents.

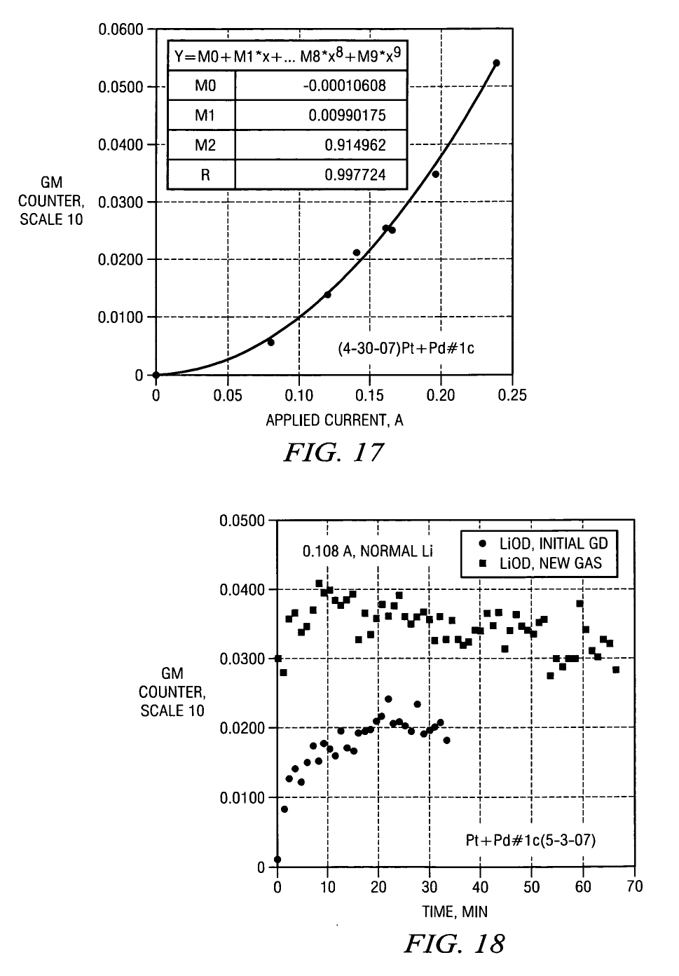

Once activity became stable and constant, the activity is found to be related to current, as shown in FIG. 17. FIG. 17 is a plot of the effect of current on the activity. This behavior shows that this activity is depends on the current and not on voltage. On many occasions, pumping out the system and adding fresh D₂ resulted in increased activity, as shown in FIG. 18. FIG. 18 is a plot of the effect on activity of changing the D2 gas in the cell. New gas was especially beneficial when the total pressure had increased because H₂O had degassed from the shroud.

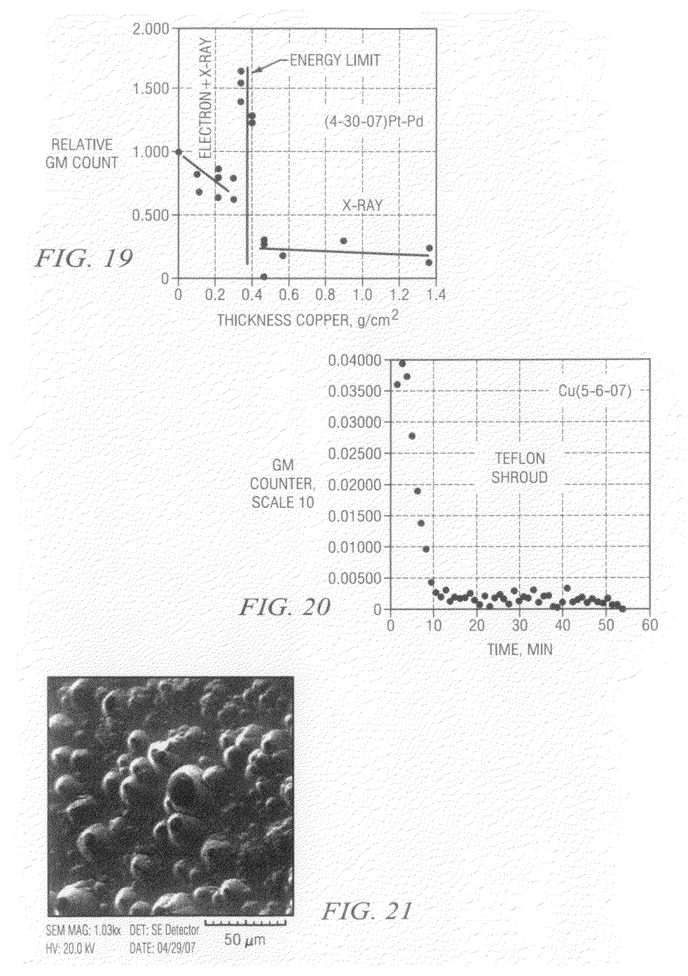

After the absorber sets were added, the behavior shown in FIG. 19 was found. FIG. 19 is a plot of the effect of absorber thickness on the relative activity. Initially, addition of greater thickness resulted in a steady reduction in activity. However, near the limit, activity suddenly increased and then dropped to near zero. This behavior is typical of a monoenergetic electron having an energy of 0.8±0.1 MeV.

The behavior depended neither on the material used as the shroud nor on the material used as the cathode within the range of materials, with generally one exception. Switching to a Teflon shroud caused a previously active cathode to become inactive (FIG. 20). FIG. 20 is a plot of the effect of using a Teflon shroud. However, all cathode materials formed cones on their surface, an example of which is shown in FIG. 21, with shroud material on the tips of many cones. Although the cathodes lost weight, they gained thickness. FIG. 21 is a depiction of a surface of a Pd+Pt alloy after being subjected to gas discharge in D₂ using a ceramic shroud containing the oxides of Mg, Al, Na, Si and K. The black regions contain shroud material that is not present elsewhere.

In addition to the EE produced by the present gas discharge cell, it further produces CP as described below. In an effort to recreate the EE, addition of D₂O to the cell along with D₂ was found to produce a different kind of emission at higher voltages. In fact, any oxygen containing vapor would work equally well. This emission was distinguished from the EE emission by being stopped by even thin plastic (1.9 mg/cm²) and being very sensitive to applied voltage rather than to the current. In addition, behavior was dependent on a number of variables once a critical voltage had been reached.

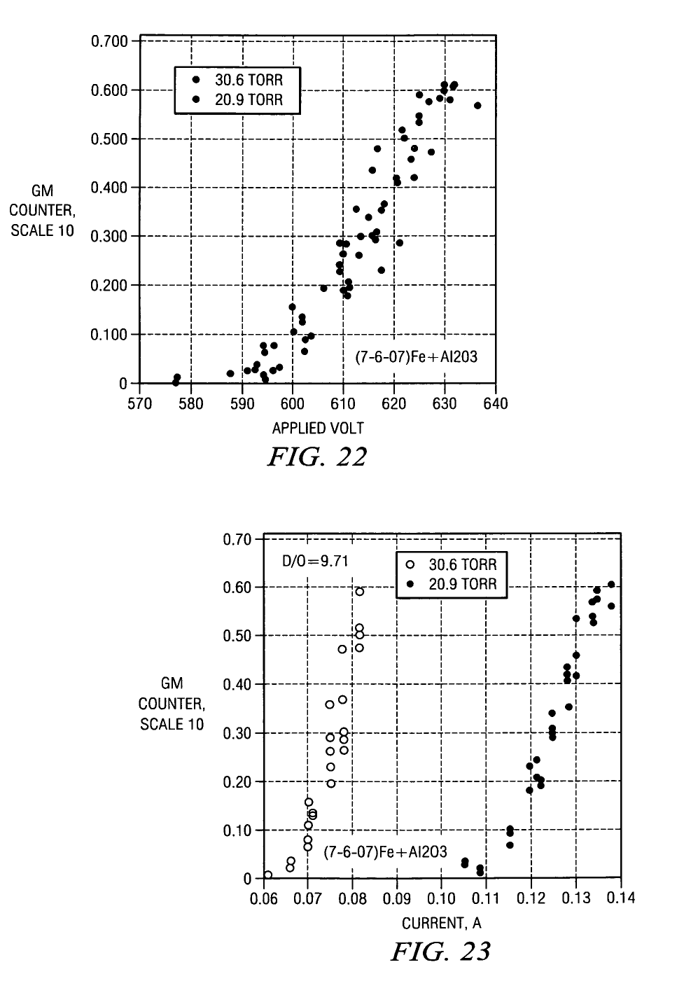

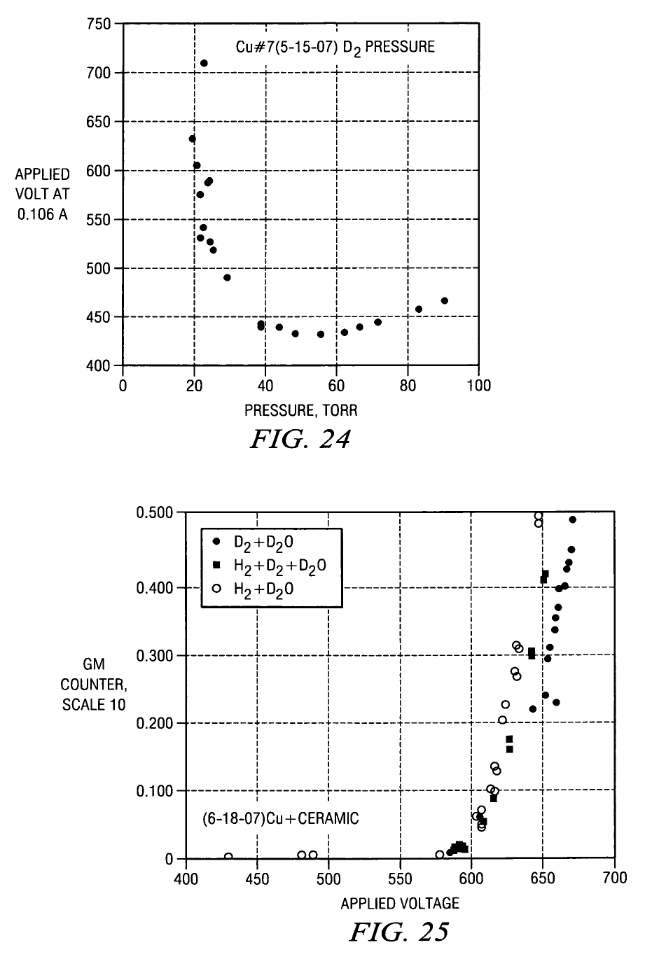

As shown in FIG. 22, the effect of voltage was not very sensitive to the D₂ pressure. FIG. 22 is a plot of the effect of voltage on the activity at two different total pressures. In contrast, the current (FIG. 23) was very sensitive to this variable. FIG. 23 is a plot of the effect of current on the activity at two different total pressures. In fact, simply reducing the pressure would frequently initiate activity because the anode voltage increases when pressure is reduced, as shown in FIG. 24. FIG. 24 is a plot of the relationship between anode voltage and total pressure.

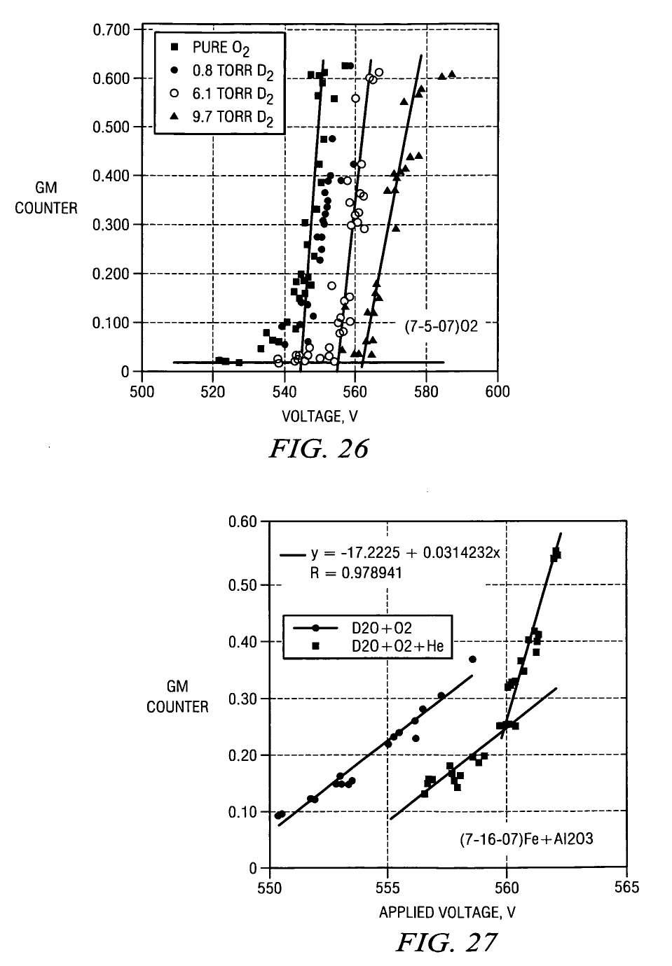

As long as the D/O ratio is the same, the effect of voltage does not depend on whether oxygen came from D₂O, H₂O or O₂, as shown in FIG. 25. FIG. 25 is a plot of the effect of H₂O, H₂ and D₂O on the relationship between anode voltage and activity. In fact, activity would result when pure oxygen is used and the behavior is consistent with a very small D/O ratio created by the unavoidable D₂ impurity that is removed from the cell wall, as shown in FIG. 26. FIG. 26 is a plot of the effect of various amounts of D₂ mixed with O₂. The residual deuterium retained by the cell between runs, as measured using a RGA, provides the necessary deuterium even though the cell was pumped to less than 10⁻⁵ Torr before oxygen is added. Oxygen is provided using O₂, H₂O, D₂O, and/or CO₂, sometimes with helium added. All of these combinations worked well and gave consistent behavior.

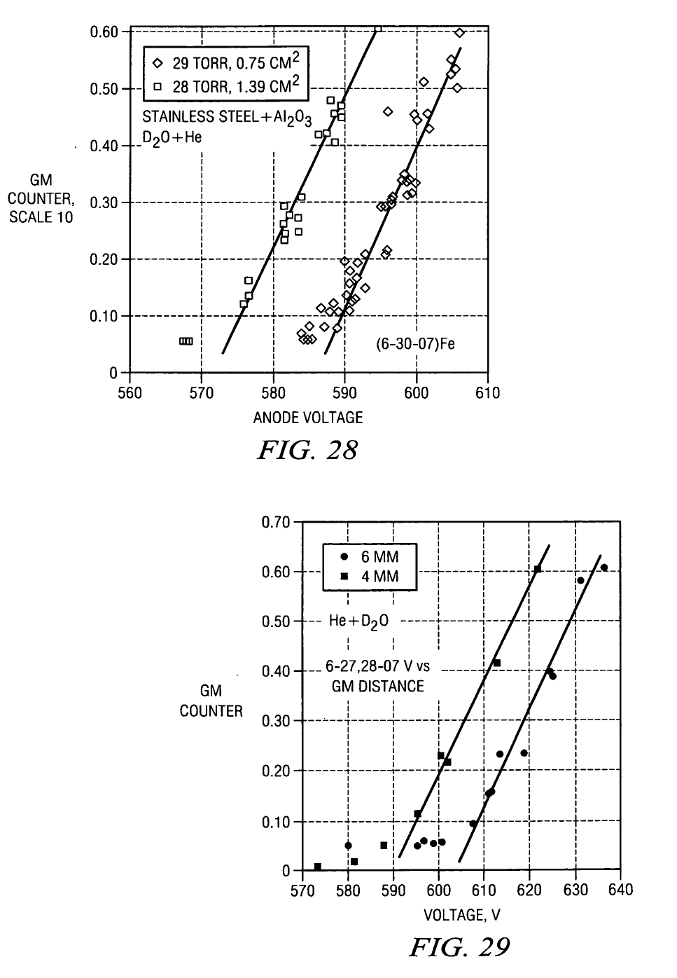

On one occasion, addition of helium showed evidence for a different mechanism besides the one caused by oxygen, as indicated by a break in slope toward higher activity at higher voltages in FIG. 27. FIG. 27 is a plot of the effect of addition of He to a mixture of D₂O and O₂. Behavior is affected by the size of the cathode surface exposed to glow discharge, shown in FIG. 28. FIG. 28 is a plot of the effect of the exposed area of the cathode. This change in area also results in a change in the average resistance of the discharge from 5571 ohm at 0.75 cm² to 6318 ohm at 1.39 cm². While the area was increased by a factor of 1.85, the resistance increased only by a factor of 1.13. In other words, the effect is not only related to the change in area. A change in voltage gradient also appears to be important.

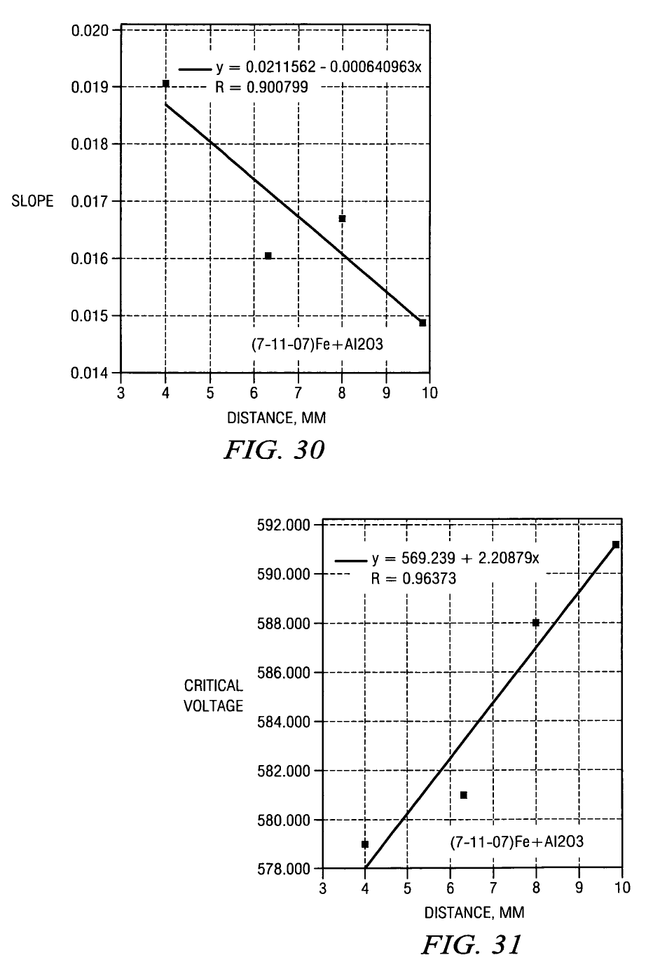

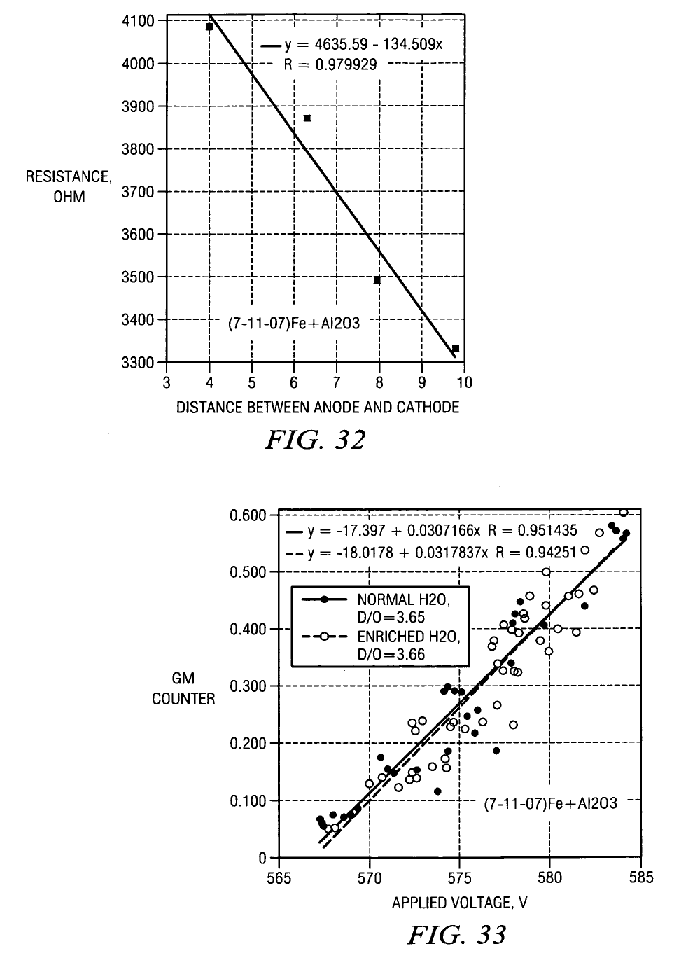

Changing the anode-cathode distance also changes the effect of voltage, as shown in FIG. 29. FIG. 29 is a plot of the effect of anode-cathode distance. FIGS. 30, 31 and 32 show that the distance also affects the slope, the critical voltage and the resistance of the discharge. FIG. 30 is a plot of the slope vs distance; FIG. 31 is a plot of the critical voltage vs distance; and FIG. 32 is a plot of the discharge resistance vs distance.

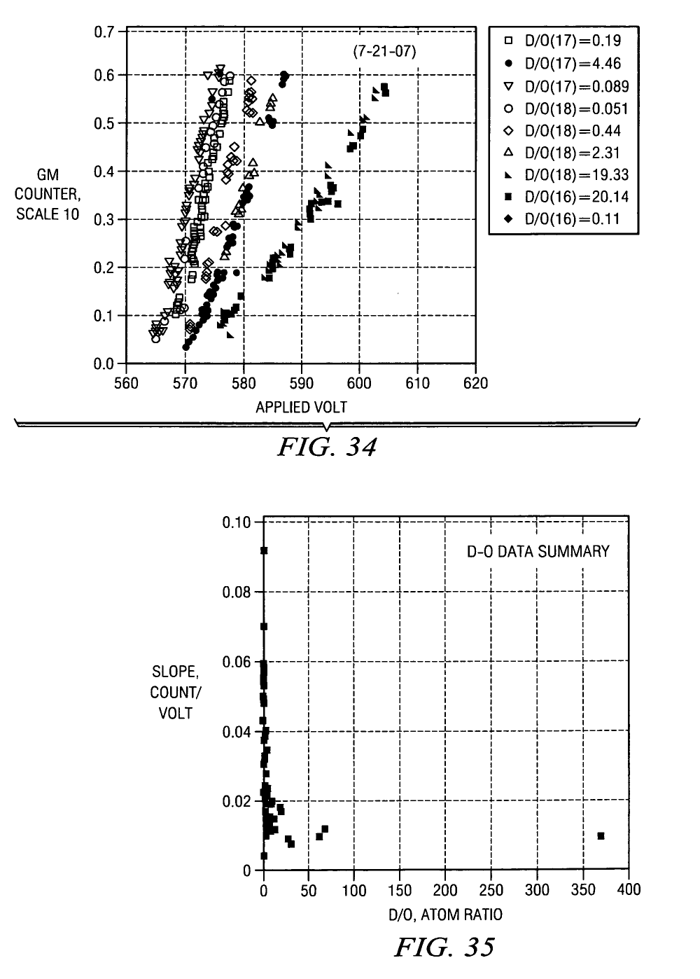

The effect of ¹⁷O (70%) and ¹⁸O (95%) is explored by adding H₂O that is enriched in these isotopes. The effect of ¹⁷O enrichment, with other variables remaining constant, is shown in FIG. 33. FIG. 33 is a plot of the effect of ¹⁷O (70%) oxygen enrichment on the behavior. No effect is observed using either of these two isotopes over a broad range of D/O atom ratios, an example of which is shown in FIG. 34. FIG. 34 is a plot of the examples of the effect of various D/O ratios on the behavior of activity.

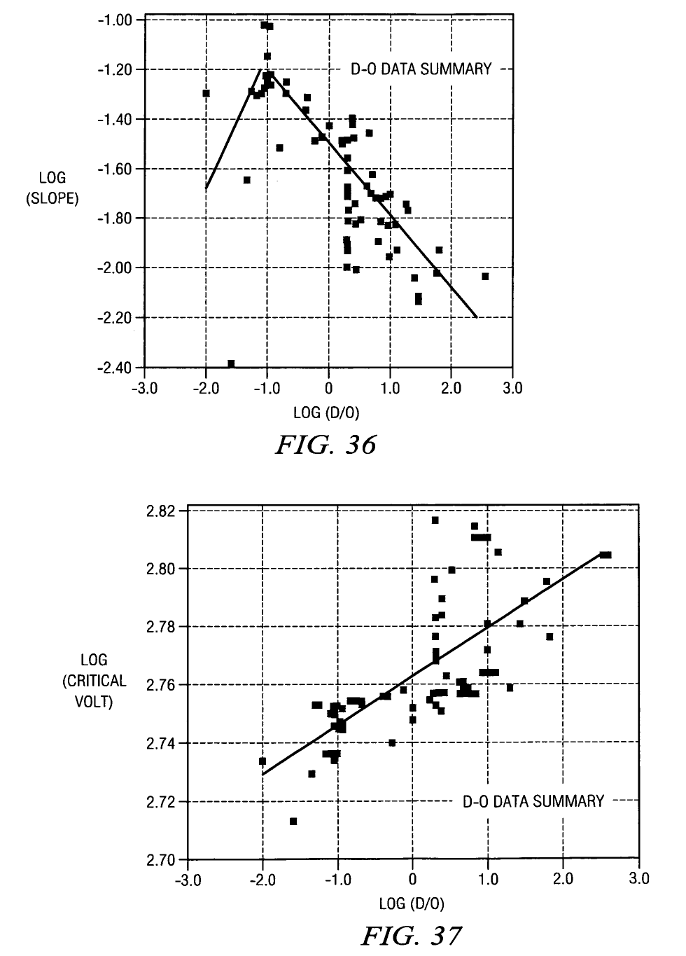

After studying a wide range of D/O ratios, a basic relationship between the D/O ratio and the slope of the activity vs voltage and the critical voltage became apparent. When all measurements of slope are plotted as a function of D/O ratio (FIG. 35) a major effect is obviously located in the high oxygen region. FIG. 35 is a plot of the relationship between slope of volt vs activity and the D/O atom ratio. A better view is provided by plotting the log of the slope vs the log of the D/O ratio, shown in FIG. 36. FIG. 36 is a plot of the relationship between log slope and log D/O ratio. The largest effect of voltage above the critical voltage on the emission rate is found at 10 oxygen atoms for each deuterium atom. A basic relationship is also seen between the log critical voltage and log D/O ratio (FIG. 37). FIG. 37 is a plot of the relationship between log critical voltage and log D/O ratio. Much of the scatter in FIGS. 36 and 37 is caused by the effect of the other variables, as described previously.

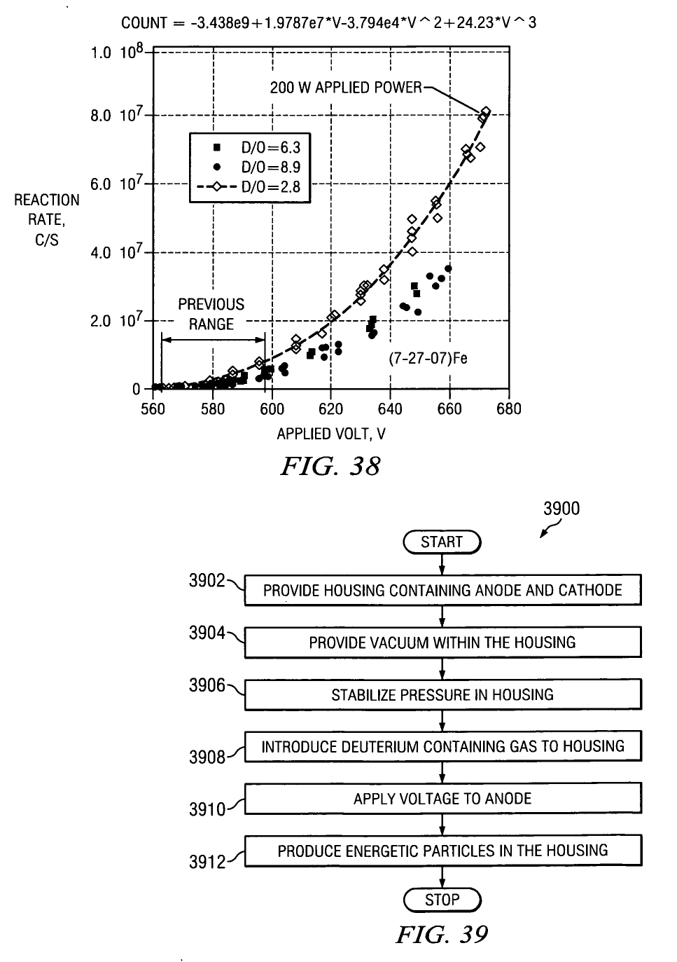

Once the ability to count particles became available, activity was increased by increasing the anode voltage above the previous limit. Because the GM tube is located further from the cathode than was previously the case, measured count rate is caused by a higher activity at the cathode. The plot of activity vs anode voltage, shown in FIG. 38, takes this change in geometry into account. FIG. 38 is a plot of the relationship between reaction events at the cathode vs anode voltage. Reaction rates at the cathode near 10⁹ events/sec have been achieved before the voltage became so high that it discharged to the walls of the cell rather than to the cathode.

The radiation, designated EE, has the characteristics of electron emission having a single energy of 0.8±0.1 MeV, based on its ability to pass through absorbers. This conclusion is possible because an electron has a definite range in matter that depends only on its energy. This range can be accurately measured by imposing material of increasing thickness until no electron is able to reach the detector. As electrons approach their maximum range, X-rays produced by Bremsstrahlung add to the unabsorbed electron flux, resulting in increased count just before all of the electrons are absorbed. Once all electrons have been stopped, only the weak X-ray remains, which is gradually reduced by additional absorber. Such ideal behavior is observed when electrons have a single energy, but not when the electrons result from beta emission. Beta emission results from the destruction of a neutron that is accompanied by emission of a neutrino. This additional particle carries a variable fraction of the energy. As a result, beta emission has a range of energy that obscures the behavior seen here. Therefore, the observed behavior shows that this radiation does not result from beta decay. Whatever the source, the radiation disappears within less than a second after current is stopped, except on one occasion. This one event produced a decay with a half-life of 24 min.

The reaction that produces these electrons involves another component besides deuterium, the concentration of which is directly related to the emission rate. This component grows in concentration and reaches a steady value in about 100 min while current is applied. When the current is turned off, the amount of this component decays away without producing emission with a half-life between 24 and 54 min, depending on how the measured values are interpreted. The difficulty in reproducing this emission after the cell was cleaned indicates that the material from which this component is produced is normally not in the vacuum apparatus used, which rules out oxygen, hydrogen, and carbon, as well as the materials used as the cathodes and shrouds. The EE is only produced in the presence of deuterium and this unknown component, and at a rate that is proportional to the number of ions being created by the current. Oxygen and fluorine appear to destroy this component. The reaction rate is not related to the voltage between the anode and cathode, although sufficient voltage must be present to cause a gas discharge. The reaction that produces EE does not seem to be related to the reaction that makes the other detected radiation CP because the two emissions are not seen to occur at the same time nor under the same conditions.

The other emission P is consistent with the behavior of 3 MeV protons that result from tritium formation. The emission rate is related to the amount of oxygen, monoatomic oxygen, diatomic oxygen, and/or both, as well as forms of oxygen not described by this convention from any source mixed with deuterium from any source, provided a voltage above a critical value is applied. A logarithmic relationship between the D/O atom ratio and the emission rate is apparent and implies that the process involves a series of preliminary reactions between oxygen and deuterium with 10 oxygen atoms interacting with each deuterium atom before a charged particle is produced. Because this relationship is not altered by the isotope of oxygen used, the nucleus of oxygen is not involved in the process. Therefore, apparently only its electron structure is important. This structure is proposed to be produced on the cathode surface regardless of the chemical form of oxygen in the gas or the other elements in or on the cathode surface. In addition, the chemical form of the deuterium in the gas is also unimportant—D₂ or D₂O being equally effective. Addition of helium helps in creating a suitable discharge and may, under certain conditions, aid the process that produces the emission. Addition of nitrogen or argon causes an unstable discharge, which makes achieving the required voltage difficult.

This emission occurs almost immediately after the critical voltage as been reached, with only a brief but variable delay of a few minutes at most. Typically, runs show very little difference between the activity obtained while going up in voltage and that obtained next by going down. In other words, the activity is not sensitive to changes in the chemical and physical structure of the cathode surface caused by sputtering. Whatever process makes this radiation, it is not very sensitive to the chemistry of the cathode surface. However, it is sensitive to the voltage gradient between the anode and cathode. This gradient can be changed by changing the distance between the anode and cathode and by changing the area of the cathode exposed to the discharge. Both changes alter the critical voltage and the slope of activity produced by changing the total voltage. Apparently, the greater the gradient, the greater the emission rate. However, because the discharge region is very non-uniform, just where in the discharge this gradient effect applies is not clear. Presumably, the largest gradient is where the emitted light is most intense, which is near the cathode surface.

Energetic emissions, typical of nuclear reactions, can be initiated in a glow discharge cell containing deuterium provided certain other atoms are present in sufficient concentration. One of these “helper” atoms is oxygen, in a form not established by this disclosure, and another may be helium. Reaction rates at the cathode having values required to make detectable heat energy can be achieved. This unexpected and anomalous observation is easy to duplicate when the required conditions have been achieved.

In addition, the energetic particles produced by the present invention may be used for additional purposes, such as heat production (energy, tritium production, and radioactive waste processing. Also, the present Energetic Particles System may be used for electrolysis, gas discharge, and gas loading operations and experiments.

In addition to the aforementioned aspects and embodiments of the present Energetic Particles System, the present invention further includes methods for producing repeatable energetic particles. FIG. 39 illustrates an embodiment 3900 of a process flow diagram for producing energetic particles. In step 3902, a housing of a gas discharge cell is provided that contains an anode and a cathode as described above. In step 3904, a vacuum source/apparatus connected to the housing provides a vacuum to the housing. Various valves and piping may be used to connect and control the application of the vacuum source to the housing. For example, a valve may be opened along a pipe between the vacuum source and the housing to allow for the vacuum source to apply a vacuum to the housing. In step 3906, once the proper negative pressure is obtained in the housing, the valve may be closed thus removing the effects of the vacuum source and sealing and stabilizing the negative pressure within the housing of the gas discharge cell. Gauges may be used to determine the amount of negative pressure within the housing to provide a measurement of when to close the valve to the vacuum source. The gauges may include a single negative pressure gauge or a combination of negative pressure gauges to measure the negative pressure.

Once the pressure is held constant within the housing, then in step 3908, a single gas or a mixture of gases is introduced into the housing. In one embodiment, the gas or mixture of gases are introduced into the housing separately or at substantially the same time. Manifolds and valves located at the gas sources provide means for controlling the amount of gas to be introduced into the housing. By introducing the gas or mixture of gases into the housing, the pressure increases to a desired value. In step 3910, a voltage is applied to the anode and in Step 3912 a discharge over the cathode surface of energetic particles is produced as described herein.

There has been described an Energetic Particles System. It should be understood that the particular embodiments described within this specification are for purposes of example and should not be construed to limit the invention. Further, it is evident that those skilled in the art may now make numerous uses and modifications of the specific embodiment described, without departing from the inventive concepts. For example, additional or different ratios of gases and different voltages and currents, different cathode materials, and different anode materials may be used without departing from the inventive concepts.

What is claimed:

1. A system for producing energetic particles comprising:
a housing containing an anode and a cathode that are connected to a voltage supply,
a shroud substantially surrounding said cathode, said shroud consisting of an insulating material for concentrating a glow discharge on a portion of said cathode;
a vacuum source connected to said housing for providing a reduced pressure in said housing; and
a supply of at least one gas connected to said housing for introducing said at least one gas into said housing.

2. The system for producing energetic particles of claim 1 wherein said cathode is a metal selected from the group consisting of Pd, Mn, Mg, Al, Na, Si, Cr, Ca, Fe, Cu, K, and alloys of said metals.

3. The system for producing energetic particles of claim 1 wherein said voltage supply provides a pulse voltage.

4. The system for producing energetic particles of claim 1 wherein said reduced pressure is between 0 Torr and 500 Torr

5. The system for producing energetic particles of claim 1 wherein said at least one gas is selected from the group consisting of O₂, H₂O, D₂O, D₂, CO₂, and helium mixed with a gas containing deuterium.

6. The system for producing energetic particles of claim 1 wherein said cathode is made from a material selected from the group consisting of Pd, Mn, Mg, Al, Na, Si, Cr, Ca, Fe, Cu, K, and alloys of said material.

7. The system for producing energetic particles of claim 1 wherein said anode is made from a material selected from the group consisting of Pd, Pt, Au, Ni, stainless steel, and alloys of said material.

8. The system for producing energetic particles of claim 1 wherein said voltage supply provides a voltage from about 500 V to a voltage required to produce the desired emission rate of said energetic particles.

9. A method for producing energetic particles comprising:
providing a housing containing an anode and a cathode;
providing a shroud substantially surrounding said cathode, said shroud consisting of an insulating material for concentrating a glow discharge on a portion of said cathode;
producing a reduced pressure in said housing;
introducing at least one gas containing at least one of deuterium, monoatomic oxygen, and diatomic oxygen into said housing;
supplying a voltage to said anode; and
producing said energetic particles in said housing.

10. The method for producing energetic particles of claim 9 further comprising:
adjusting said voltage to said anode.

11. The method for producing energetic particles of claim 9 wherein said reduced pressure is from about 0 Torr to about 500 Torr.

12. The method for producing energetic particles of claim 9 wherein said voltage is from about 0 V to about 1000 V.

13. The method for producing energetic particles of claim 9 further comprising:
adjusting the distance between said anode and said cathode.

14. The method for producing energetic particles of claim 9 wherein said at least one gas containing deuterium includes at least one gas selected from the group consisting of H₂, H₂O, D₂O, CO₂, and helium mixed with a gas containing deuterium.

15. The method for producing energetic particles of claim 9 wherein said cathode is made from a material selected from the group consisting of Pd, Mn, Mg, Al, Na, Si, Cr, Ca, Fe, Cu, K, and alloys of said metals.

16. The method for producing energetic particles of claim 9 wherein said anode is made from a material selected from the group consisting of Pd, Pt, Au, Ni, stainless steel, and alloys of said material.

17. The method for producing energetic particles of claim 9 wherein said cathode further comprises a layer of an oxide of a metal selected from the group consisting of Pd, Mn, Mg, Al, Na, Si Cr, Ca, Fe, Cu, K, and alloys of said metals.

18. A system for producing energetic particles comprising:
means for providing a housing containing an anode and a cathode;
means for providing a shroud substantially surrounding said cathode, said shroud consisting of an insulating material for concentrating a glow discharge on a portion of said cathode;
means for producing a reduced pressure in said housing;
means for introducing at least one gas containing at least one of deuterium, monoatomic oxygen, and diatomic oxygen into said housing;
means for supplying a voltage to said anode; and
means for producing said energetic particles in said housing.

19. The system for producing energetic particles of claim 18 further comprising:
means for adjusting said voltage to said anode.

20. The system for producing energetic particles of claim 18 wherein said reduced pressure is from about 0 Torr to about 500 Torr.

21. The system for producing energetic particles of claim 18 wherein said voltage is from 500 V to a voltage required to produce the desired emission rate of said energetic particles.

22. The system for producing energetic particles of claim 18 further comprising:
means for adjusting the distance between said anode and said cathode.

23. The system for producing energetic particles of claim 18 wherein said at least one gas containing deuterium includes at least one gas selected from the group consisting of H₂O, D₂O, CO₂, and helium mixed with a gas containing deuterium.

24. The system for producing energetic particles of claim 18 wherein said cathode is made from a material selected from the group consisting of Pd, Mn, Mg, Al, Na, Si, Cr, Ca, Fe, Cu, K, and alloys of said material.

25. The system for producing energetic particles of claim 18 wherein said anode is made from a material selected from the group consisting of Pd, Pt, Au, Ni, stainless steel and alloys of said material.
